(19) United States
(12) Patent Application Publication
(10) Pub. No.: US 2026/0110296 A1
(43) Pub. Date: Apr. 23, 2026

(54) VALVE RETAINER SECUREMENT FOR FLUID END

(71) Applicant: GD Energy Products, LLC, Tulsa, OK (US)

(72) Inventor: Vadim Kachkovskiy, Spring Mills, PA (US)

(21) Appl. No.: 18/922,796

(22) Filed: Oct. 22, 2024

(51) Int. Cl. F04B 53/10; F16K 15/02

(52) U.S. Cl. CPC F04B 53/10; F16K 15/025

(57) ABSTRACT

A valve assembly for a fluid end includes a valve configured to seal a bore segment of the fluid end, as well as a retainer configured to secure the valve within the fluid end. The retainer includes a flange having a surface configured to engage a wall of the fluid end and an extension extending from the surface and configured to extend into a groove formed in the fluid end to block rotation of the retainer within the fluid end.

### TECHNICAL FIELD

The present disclosure relates to the field of high pressure reciprocating pumps and, in particular, to fluid ends of high pressure reciprocating pumps that include a groove for securing a retainer therein.

### BACKGROUND

High pressure reciprocating pumps are often used to deliver high pressure fluids during earth drilling operations. A reciprocating pump includes a fluid end that defines several different internal bores, adjacent ones of which intersect. Valves are typically installed in the fluid end to control fluid flow through these bores during operation and retainers may be used to secure the valves in certain locations within the bores. The retainers may also provide a surface against which a biasing spring for a valve may act. Thus, the valves may be biased toward a closed position that blocks fluid flow through a bore segment of the fluid end. It is desirable for the retainers to be secured within the fluid end to provide desirable functionality to bias the valves to the closed position.

### SUMMARY

The present application relates to a fluid end of a reciprocating pump. The techniques discussed herein may be embodied as at least a valve assembly, a fluid end, and a retainer.

More specifically, in accordance with at least one embodiment, the present application is directed to a valve assembly for a fluid end. The valve assembly includes a valve configured to seal a bore segment of the fluid end, as well as a retainer configured to secure the valve within the fluid end. The retainer includes a flange having a surface configured to engage a wall of the fluid end and an extension extending from the surface and configured to extend into a groove formed in the fluid end to block rotation of the retainer within the fluid end.

In accordance with another embodiment, the present application is directed to a fluid end. The fluid end includes an inner surface with a groove, as well as a valve assembly with a retainer configured to secure the valve assembly within the fluid end. The retainer includes a flange configured to engage the inner surface of the fluid end and an extension extending from the flange and configured to extend into the groove of the inner surface of the fluid end to block rotation of the retainer relative to a wall of the fluid end.

In accordance with yet another embodiment, the present application is directed to a retainer of a valve assembly for a fluid end. The retainer includes a base portion configured to couple to a biasing member to urge a valve of the valve assembly away from the retainer, a retainer portion extending from the base portion, and an extension extending from a surface of the retainer portion. The retainer portion extends at least partially circumferentially about a center axis extending through the retainer, and the extension is configured to extend into a groove formed in the fluid end to block rotation of the retainer within the fluid end.

### BRIEF DESCRIPTION OF THE DRAWINGS

To complete the description and in order to provide for a better understanding of the present application, a set of drawings is provided. The drawings form an integral part of the description and illustrate embodiments of the present application, which should not be interpreted as restricting the scope of the disclosure, but just as examples. The drawings comprise the following figures:

FIG. 1A is a perspective view of a reciprocating pump including a fluid end in which techniques described herein are incorporated.

FIG. 1B is a schematic, side cross-sectional view of a fluid end of another reciprocating pump in which techniques described herein are incorporated.

FIG. 2A is a schematic, isometric sectional view of a fluid end including a retainer, in accordance with embodiments discussed herein.

FIGS. 2B and 2C are additional schematic, isometric sectional views of the fluid end of FIG. 2A that show fluid end components in various states of installation, in accordance with embodiments discussed herein.

FIGS. 3A and 3B are detailed views of a fluid end with a retainer in various states of installation, in accordance with embodiments discussed herein.

FIG. 4 is a detailed view of a fluid end with another retainer, in accordance with embodiments discussed herein.

FIG. 5 is a detailed view of a fluid end with yet another retainer, in accordance with embodiments discussed herein.

FIGS. 6 and 7 are flowcharts of methods related to positioning a retainer with respect to a fluid end, in accordance with embodiments discussed herein.

Like reference numerals have been used to identify like elements throughout this disclosure.

### DETAILED DESCRIPTION

The following description is not to be taken in a limiting sense but is given solely for the purpose of describing the broad principles of the disclosure. Embodiments of the disclosure will be described by way of example, with reference to the above-mentioned drawings showing elements and results according to the present disclosure.

Generally, the present application is directed to a fluid end of a reciprocating pump and/or components thereof. The fluid end may include a valve assembly that includes a retainer and a valve to help seal a bore segment of the fluid end. For example, a biasing member may bias the retainer and the valve away from one another to urge the valve to a closed position that seals the bore segment.

In accordance with the present application, the fluid end includes a groove to help secure the retainer in the fluid end, ensuring the biasing member can function to urge the valve to the closed position. The retainer includes a base portion configured to couple to the biasing member, as well as a retainer portion extending from the biasing member. An extension extends from the retainer portion, and the groove is formed into an inner surface of a wall of the fluid end such that positioning the extension in the groove causes the wall to capture the extension. The retainer is then blocked from rotating relative to the wall, thereby securing the retainer within the fluid end. Accordingly, the position of the retainer may be better maintained to correspondingly position the valve desirably (e.g., in the closed position) in the fluid end. For example, the engagement between the extension and the groove may help the retainer withstand forces imparted during operation of the fluid end that otherwise may undesirably move (e.g., rotate and/or tilt) the retainer.

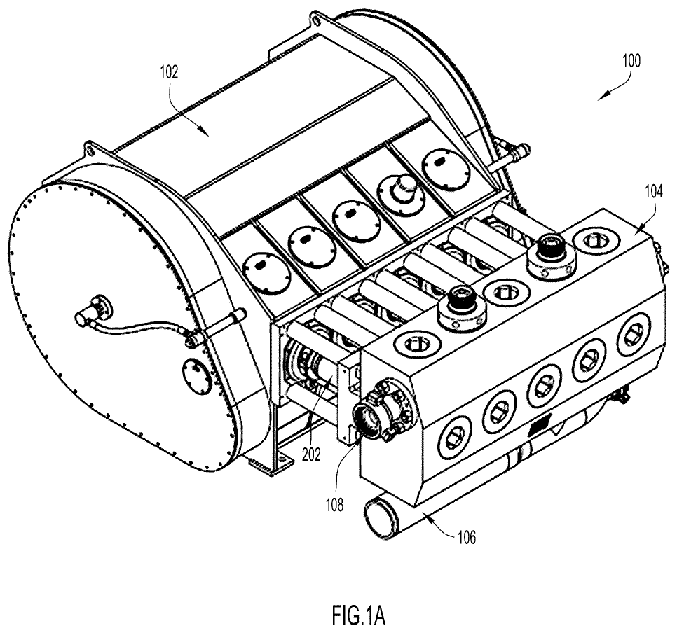

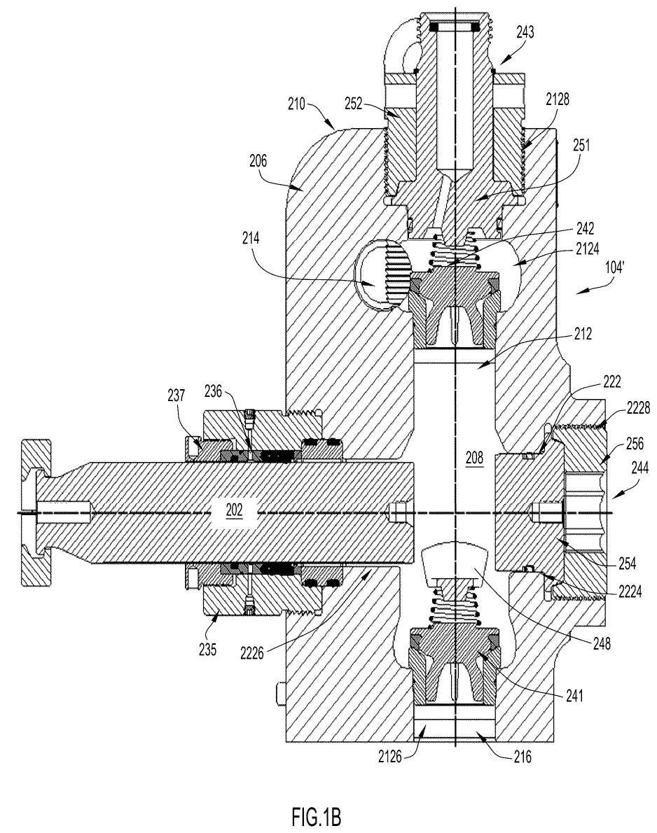

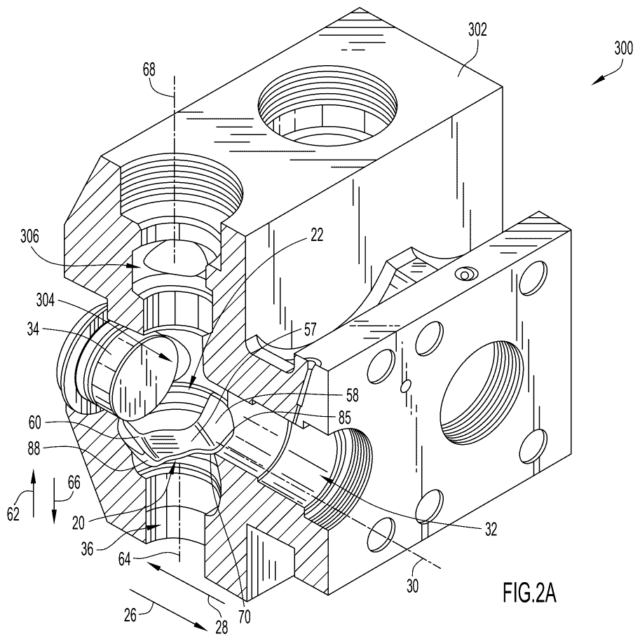

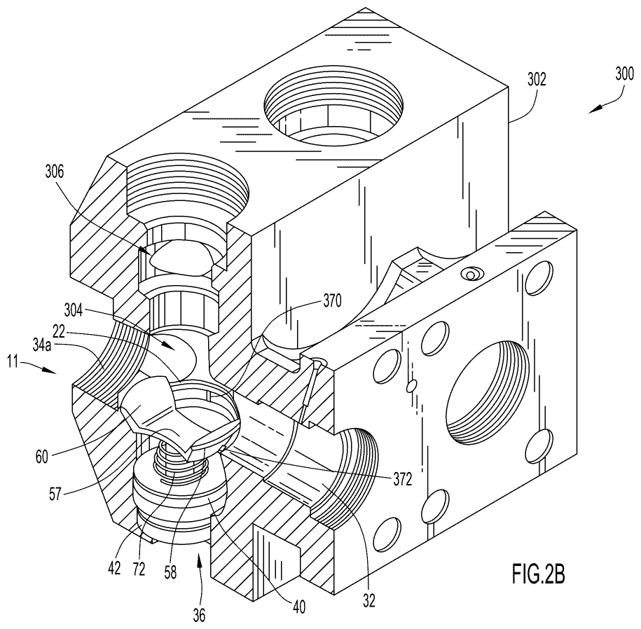

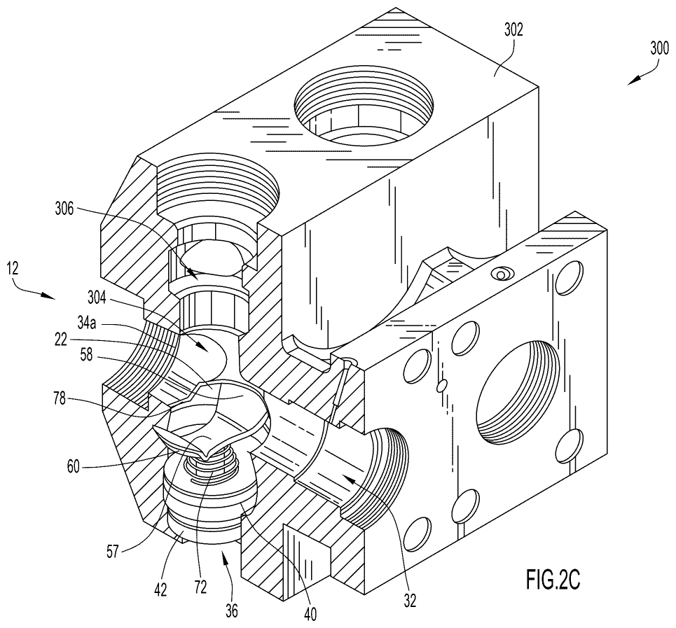

To best understand the techniques presented herein, it is important to understand operations and arrangements of fluid ends. Accordingly, FIGS. 1A and 1B illustrate a fluid end and describe its parts and components at a relatively high-level. Then, FIGS. 2A-2C illustrate a fluid end to demonstrate how certain retainers (e.g., spring retainers) may be installed and secured within a fluid end to support a valve in the fluid end.

FIG. 1A illustrates a reciprocating pump 100 that includes features discussed herein. The reciprocating pump 100 includes a power end 102 and a fluid end 104. The power end 102 includes a crankshaft that drives a plurality of reciprocating elements within the fluid end 104 to pump fluid at high pressure. Generally, the power end 102 is capable of generating forces sufficient to cause the fluid end 104 to deliver high pressure fluids to earth drilling operations. For example, the power end 102 may be configured to support hydraulic fracturing (i.e., fracking) operations, where fracking liquid (e.g., a mixture of water and sand) is injected into rock formations at high pressures to allow natural oil and gas to be extracted from the rock formations. However, to be clear, this example is not intended to be limiting and the present application may be applicable to both fracking and drilling operations, among other operations.

Often, the reciprocating pump 100 may be quite large and may, for example, be supported by a semi-tractor truck (“semi”) that can move the reciprocating pump 100 to and from a well. Specifically, in some instances, a semi may move the reciprocating pump 100 off a well when the reciprocating pump 100 requires maintenance. However, a reciprocating pump 100 is typically moved off a well only when a replacement pump (and an associated semi) is available to move into place at the well, which may be rare. Thus, often, the reciprocating pump is taken offline at a well and maintenance is performed while the reciprocating pump 100 remains on the well. If not for this maintenance, the reciprocating pump 100 could operate continuously to extract natural oil and gas (or conduct any other operation). Consequently, any improvements that extend the lifespan of components of the reciprocating pump 100, especially typical “wear” components, and extend the time between maintenance operations (i.e., between downtime) are highly desirable.

Still referring to FIG. 1A, but now in combination with FIG. 1B, in various embodiments, the fluid end 104 may be shaped differently and/or have different features, but may still generally perform the same functions, define similar structures, and house similar components. To illustrate potential shape variations, FIG. 1B shows a side, cross-sectional view of a fluid end 104′ with different internal and external shaping as compared to the fluid end 104. However, because the fluid end 104 and the fluid end 104′ have many operational similarities, FIGS. 1A and 1B are labeled with the same reference numerals and are both described with respect to these common reference labels.

The cross-sectional view of FIG. 1B is taken along a central axis of one of the reciprocating elements 202 included in the reciprocating pump 100. Thus, although FIG. 1B depicts a single pumping chamber 208, it should be understood that the fluid end 104′ can include multiple pumping chambers 208 arranged side-by-side. In fact, in at least some embodiments, a casing 206 of the fluid end 104′ forms a plurality of pumping chambers 208 and each chamber 208 includes a reciprocating element 202 (e.g., a plunger) that reciprocates within the casing 206. However, side-by-side pumping chambers 208 need not be defined by a single casing 206. For example, in some embodiments, the fluid end 104′ may be modular, and different casing segments may house one or more pumping chambers 208. In any case, the one or more pumping chambers 208 are arranged side-by-side so that corresponding conduits are positioned adjacent each other and generate substantially parallel pumping action. Specifically, with each stroke of the reciprocating element 202, low pressure fluid is drawn into the pumping chamber 208 and high pressure fluid is discharged.

As can be seen in FIG. 1B, the pumping paths and pumping chamber 208 of the fluid end 104′ are formed by conduits that extend through the casing 206 to define openings at an external surface 210 of the casing 206. More specifically, a first conduit 212 extends longitudinally (e.g., vertically) through the casing 206 while a second conduit 222 extends laterally (e.g., horizontally) through the casing 206. Thus, the first conduit 212 intersects the second conduit 222 to at least partially (and collectively) define the pumping chamber 208. In the fluid end 104 and the fluid end 104′, the conduits 212 and 222 are substantially cylindrical, but the diameters of the conduits 212 and 222 may vary throughout the casing 206 so that the conduits 212 and 222 can receive various structures, such as sealing assemblies, valves, or components thereof. For example, the conduits 212 and/or 222 can support a retainer in or adjacent the pumping chamber 208 that allows a valve 241 to control a flow of fluid through the first conduit 212, as is detailed below.

Regardless of the diameters of the conduit 212 and 222, each conduit 212 and 222 may include two segments, each of which extends from the pumping chamber 208 to the external surface 210 of the casing 206 and may also be referred to as a bore segment. Specifically, the first conduit 212 includes a first bore segment 2124 and a second bore segment 2126 that opposes the first bore segment 2124. Likewise, the second conduit 222 includes a third bore segment 2224 and a fourth bore segment 2226 that opposes the third bore segment 2224. In the illustrated embodiment, the bore segments of a conduit (e.g., the bore segments 2124 and 2126 or the bore segments 2224 and 2226) are substantially coaxial, while the bore segments of different conduits are substantially orthogonal. However, in other embodiments, the bore segments 2124, 2126, 2224, and 2226 may be arranged along any desired angle or angles, for example, to intersect pumping chamber 208 at one or more non-straight angles.

In this embodiment, the first conduit 212 defines a fluid path through the fluid end 104. The second bore segment 2126 is an intake segment that connects the pumping chamber 208 to a piping system 106 (see FIG. 1A) delivering fluid to the fluid end 104. Meanwhile, the first bore segment 2124 is an outlet or discharge segment that allows compressed fluid to exit the fluid end 104′. Thus, in operation, the bore segments 2126 and 2124 may include valves 241 and 242, respectively, (e.g., one-way valves) that allow the bore segments 2126 and 2124 to selectively open. The valve 241 in the second bore segment 2126 may be secured therein by a retainer 248 (e.g., a spring retainer), which may engage with a groove of the fluid end 104′ as further described herein for securement within the fluid end 104′. Meanwhile, the valve 242 in the first bore segment 2124 may be secured therein by a closure assembly 243 that, in the example illustrated in FIG. 1B, includes a closure element 251 (also referred to as a discharge plug) that is secured in the first bore segment 2124 by a retaining assembly 252. The retaining assembly 252 is coupled to segment 2124 via threads 2128 defined by an interior wall of the first bore segment 2124. However, in additional or alternative embodiments, the closure assembly 243 and/or the retaining assembly 252 may be positioned within a groove of the fluid end 104′ for securement therein.

On the other hand, the fourth bore segment 2226 defines, at least in part, a cylinder for the reciprocating elements 202 and/or connects the casing 206 to a cylinder for the reciprocating element 202. For example, in the illustrated embodiment, a casing segment 235 is secured to the fourth bore segment 2226 and houses a packing assembly 236 configured to seal against the reciprocating element 202 disposed interiorly of the packing assembly 236. In any case, reciprocation of the reciprocating element 202 in or adjacent to the fourth bore segment 2226, which may be referred to as a reciprocation segment, draws fluid into the pumping chamber 208 via the second bore segment 2126 and pumps the fluid out of the pumping chamber 208 via the first bore segment 2124. Notably, in the illustrated arrangement, the packing assembly 236 is retained within the casing segment 235 with a retaining element 237 that is threadedly coupled to casing segment 235.

The third bore segment 2224 is an access segment that can be opened to access to parts disposed within casing 206 and/or surfaces defined within casing 206. During operation, the third bore segment 2224 may be closed by a closure assembly 244 that, in the example illustrated in FIG. 1B, includes a closure element 254 (also referred to as a suction plug) that is secured in the third bore segment 2224 by a retaining assembly 256. Notably, the retaining assembly 256 is coupled to the third bore segment 2224 via threads 2228 defined by an interior wall of the third bore segment 2224. However, in some embodiments, the second conduit 222 need not include the third bore segment 2224, and the second conduit 222 may be formed from a single segment (e.g., the fourth bore segment 2226) that extends from the pumping chamber 208 to the external surface 210 of the casing 206.

Overall, in operation, fluid may enter the fluid end 104′ via multiple openings, as represented by an opening 216 in FIG. 1B, and exit the fluid end 104′ via multiple openings, as represented by an opening 214 in FIG. 1B. In at least some embodiments, fluid enters the openings 216 via pipes of the piping system 106, flows through the pumping chamber 208 (e.g., due to reciprocation of a reciprocating element 202), and then flows through the openings 214 into a channel 108 (see FIG. 1B). However, the piping system 106 and the channel 108 are merely example conduits and, in various embodiments, the fluid end 104′ may receive and discharge fluid via any number of pipes and/or conduits, along pathways of any desirable size or shape.

Also, during operation, the first bore segment 2124 of the first conduit 212, the third bore segment 2224 of the second conduit 222, and the fourth bore segment 2226 of the second conduit 222 may each be “closed” segments. By comparison, the second bore segment 2126 of the first conduit 212 may be an “open” segment that allows fluid to flow from the external surface 210 to the pumping chamber 208. That is, for the purposes of this application, a “closed” segment may prevent, or at least discourage, direct fluid flow between the pumping chamber 208 and the external surface 210 of the casing 206, while an “open” segment may allow fluid flow between the pumping chamber 208 and the external surface 210.

Now turning to FIGS. 2A-2C, these Figures schematically illustrate cross-sectional views of another fluid end 300 to illustrate how a retainer (e.g., the retainer 248 of FIG. 1B) may be installed to secure a valve (e.g., the valve 241 of FIG. 1B) within the fluid end 300. The views of FIGS. 2A-2C are illustrated as being taken through a casing 302 of the fluid end 300 of a reciprocating pump, along a plane parallel to axes 30, 64, and 68, respectively, of the bore segments of the fluid end 300. For clarity and/or as a result of the sectional views, various components are shown or omitted in FIG. 2A-2C, but such omission should not be interpreted to indicate that such components are or are not included in this fluid end 300. For example, for clarity, a reciprocating element, which may be similar to the reciprocating element 202 of FIGS. 1A and 1B, is not illustrated in FIGS. 2A-2C. Similarly, FIG. 2A illustrates a plug 34 (e.g., a valve cover) that is omitted from FIGS. 2B and 2C in order to illustrate certain features of this fluid end 300. As yet another example, while a retainer 20 (e.g., a spring retainer) is disposed in a retainer recess 22 in FIGS. 2A-2C, the retainer 20 is shown supporting a biasing member 72 (e.g., a spring) that acts against a valve 40 (e.g., a suction valve) to bias the valve 40 into a closed position against its valve seat 42 in FIGS. 2B and 2C, but the components with which the retainer 20 interacts are omitted from FIG. 2A for clarity.

Similar to the fluid ends 104 and 104′ described in connection with FIGS. 1A and 1B, the fluid end 300 of FIGS. 2A-2C operates when a reciprocating element reciprocates in a first direction 26 and an opposite second direction 28 along a central axis 30 of a reciprocating bore segment 32. As the reciprocating element reciprocates in the first direction 26, the valve 40 moves off its valve seat 42 towards the retainer 20 (i.e., the valve 40 moves out of a closed position). Fluid then passes through a suction bore segment 36, over/around the retainer 20, and into a crossbore or pumping chamber 304 of the fluid end 300. When the reciprocating element then reciprocates in the opposite second direction 28, the fluid pushes another valve (e.g., a discharge valve) off its valve seat and exits the fluid end 300 via a discharge bore segment 306 centered around axis 68. In the depicted embodiment, the fluid end 300 is a single monoblock piece machined from a single casting or forging. However, the fluid end 300 could alternatively have any number of shapes or features, as mentioned above in connection with the embodiments of FIGS. 1A and 1B. For example, in other embodiments, the fluid end 300 might be flangeless.

During the aforementioned operations, forces generated by fluid flow may impart a force onto the retainer 20, such as about the axis 64 extending through the suction bore segment 36. It is desirable to secure the retainer 20 within the retainer recess 22 to maintain functionality of the retainer 20 to urge the valve 40 toward the valve seat 42. For example, it may be desirable to block movement of the retainer 20 in directions 62, 66 along the axis 68.

To this end, the retainer recess 22 axially secures the valve 40. The retainer recess 22 generally extends around a portion of the pumping chamber 304 of the fluid end 300 but is interrupted by a valve cover transition area 78 (e.g., a first inwardly extending rim) and a reciprocation bore transition area 70 (e.g., a second inwardly extending rim) so that the retainer recess 22 has two opposing sections. That is, a first portion and a second, opposite portion of the retainer recess 22 are not connected; these portions are separated by the transition areas 70 and 78, such that the retainer recess 22 is discontinuous. The transition areas 70 and 78 of this embodiment are generally rounded with a valley. Additionally, the transition areas 70 and 78 are each coplanar with the retainer recess 22 so that the plug 34 or reciprocating element installed in the fluid end 300 can extend into a rotational path defined by the retainer recess 22.

To install the retainer 20 in the fluid end 300, the retainer 20 is first oriented in a first orientation 11 (e.g., a drop-in position or pre-installation position), which is depicted in FIG. 2B. Often, the retainer 20 and the other various portions of a valve assembly (e.g., the valve 40, the valve seat 42, the biasing member 72) are installed into the suction bore segment 36 with the plug 34 and the reciprocating element removed or not yet installed into the fluid end 300. Additionally, the valve 40 and the valve seat 42 are typically installed into the suction bore segment 36 before the retainer 20 is installed therein. A biasing member 72 may be installed with the valve 40 or installed separately from the valve 40. Either way, the biasing member 72 extends from the valve 40 to the retainer 20 after these components are installed within the suction bore segment 36. That all said, when the retainer 20 is in orientation 11, a first retainer portion 58 (e.g., a first flange) of the retainer 20 is aligned and overlaps with the reciprocation bore transition area 70 (see FIG. 2A) area and a second retainer portion 60 (e.g., a second flange) is aligned and overlaps with the valve cover transition area 78 (see FIG. 2C). Accordingly, the retainer 20 can be moved (e.g., pushed) in direction 66, into/towards both the bore segment 36 and the valve 40 installed therein, to compress the biasing member 72. This compression continues until a first retainer portion 58 of the retainer 20 abuts the reciprocation bore transition area 70 and a second retainer portion 60 of the retainer 20 abuts the valve cover transition area 78. These abutments prevent further axial movement of the retainer 20 in direction 66.

As can be seen in FIGS. 2A-2C, the retainer portions 58 and 60 each comprise extensions (e.g., wings, lips) that extend from opposite sides of a base portion 57 of the retainer 20 to form a U-shaped or V-shaped configuration. Thus, when the retainer portions 58 and 60 abut the transition areas 70 and 78, the retainer 20 extends across the suction bore segment 36 and can rotate within the suction bore segment 36. Rotation of the retainer 20 moves the retainer portions 58 and 60 of the retainer 20 into the retainer recess 22 between edges of the transition areas 70 and 78. That is, rotating the retainer 20 moves a first leading edge 85 (see FIG. 2A) of the first retainer portion 58 into a first portion of the retainer recess 22 while simultaneously moving a second leading edge 88 (see FIG. 2A) of the second retainer portion 60 into a second portion of the retainer recess 22. Consequently, the retainer 20 extends across the suction bore segment 36 between the transition areas 70 and 78. Such a position of the retainer 20 is a second orientation 12 (e.g., an engaged or installed orientation), an example of which is shown in FIG. 2C.

To further secure the retainer 20 in the fluid end 300, a groove 370 (not visible in FIGS. 2A and 2C) is formed in the fluid end 300, and an extension 372 (not visible in FIGS. 2A and 2C) of the retainer 20 is configured to engage with the groove 370. As discussed herein, the engagement between the retainer 20 and the groove 370 helps block movement of the retainer 20 with respect to the casing 302, thereby maintaining the positioning of the retainer 20 within the fluid end 300.

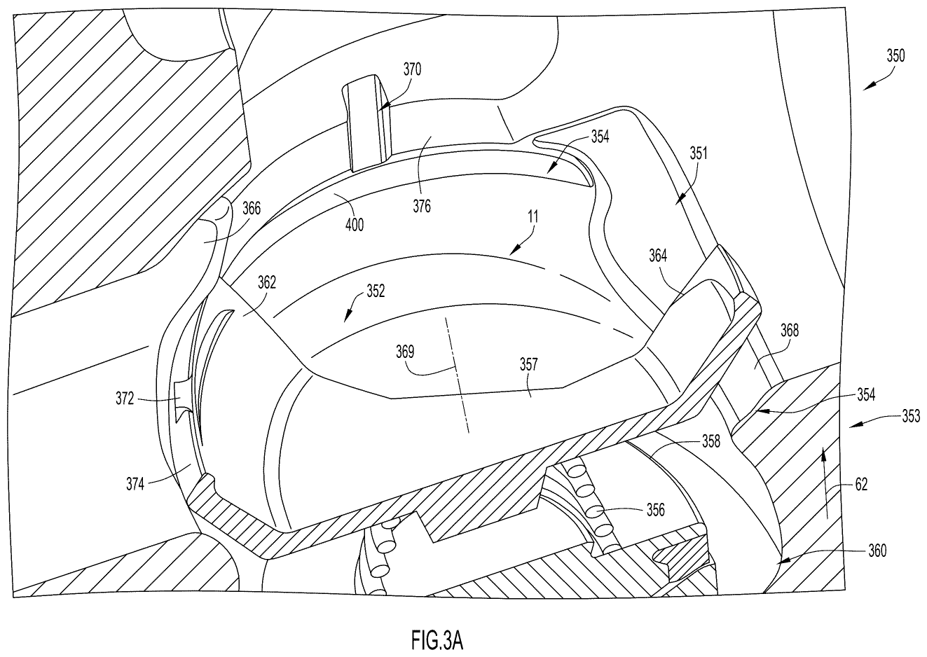

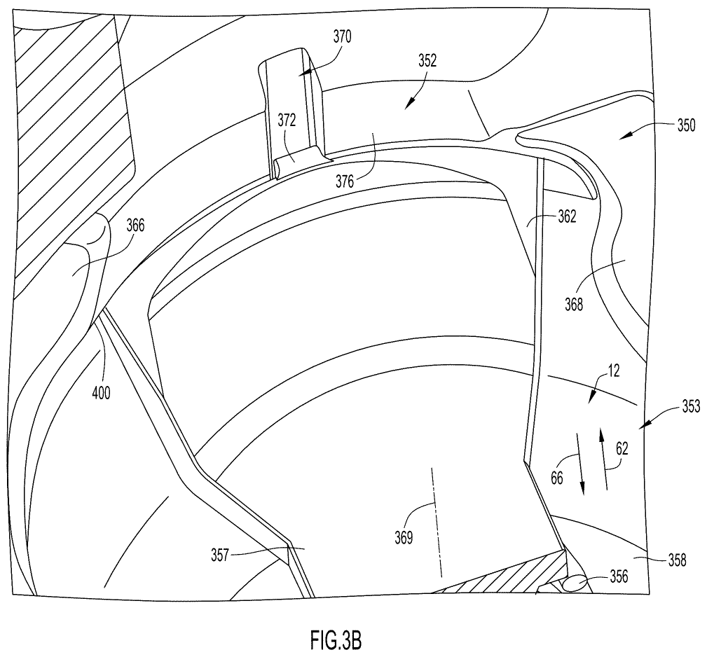

FIGS. 3A and 3B illustrate a fluid end 350 with a valve assembly 351 that includes a retainer 352 (e.g., a spring retainer) positioned in a retainer recess 353, such as at or adjacent a pumping chamber 354, with FIG. 3A depicting a sectional view and FIG. 3B depicting a detailed view of a portion of the fluid end 350 and valve assembly 351. The retainer 352 is coupled to a biasing member 356 (e.g., at a base portion 357) of the valve assembly 351, which is further coupled to a valve 358 positioned in a bore segment 360 (e.g., a suction bore segment). Thus, the retainer 352 is configured to urge the valve 358 of the valve assembly 351 into a closed position (e.g., within a valve seat) via the biasing member 356 to block fluid flow through the bore segment 360.

The retainer 352 is in the first orientation 11 in FIG. 3A. For this reason, the retainer 352 is arranged such that retainer portions 362 and 364 (e.g., flanges) abut transition areas 366 and 368 (e.g., inwardly extending rims), respectively. Abutment of the retainer 352 against the transition areas 366, 368 blocks further movement of the retainer 352 into the bore segment 360. However, in some embodiments, the retainer 352 is free to rotate while engaged with the transition areas 366 and 368. To this end, the retainer 352 includes a generally circular outer boundary shape in which the retainer portions 362 and 364 extend at least partially circumferentially about a center axis 369 extending through the retainer 352 and the valve 358. Thus, rotation of the retainer 352 may, for instance, transition the retainer 352 toward the second orientation 12, which is illustrated in FIG. 3B. The fluid end 350 includes a groove 370 that helps secure the retainer 352 in the second orientation 12.

As an example, the retainer 352 may include an extension 372 extending exteriorly away from a surface 374 (e.g., an outer surface) of the retainer portion 362, such as radially beyond the retainer portion 362. The extension 372 is configured to extend into the groove 370 to secure the retainer 352 in the second orientation 12. For example, the groove 370 is formed in an inner surface of a wall 376 (e.g., surrounding the pumping chamber 354 and/or within a bore segment, such as a discharge bore segment, opposite the bore segment 360) of the fluid end 350. Positioning the extension 372 within the groove 370 causes the wall 376 to capture the extension 372, thereby blocking rotation of the extension 372 to restrict movement of the extension 372 relative to the wall 376. For this reason, the groove 370 is shaped to enable receipt and capture of the extension 372 therein. The illustrated groove 370 and extension 372 are rectangular, but the groove 370 and the extension 372 may have any suitable corresponding shape to enable the groove 370 to receive the extension 372.

In the second orientation 12 of the retainer 352 illustrated in FIG. 3B, the retainer 352 is rotated such that the retainer portion 362 is positioned between the transition areas 366 and 368 and the extension 372 extends into the groove 370. Therefore, the wall 376 captures the extension 372 and blocks rotation of the retainer 352 relative within the fluid end 350 (e.g., toward the first orientation 11). Additionally, a portion of the wall 376 extends (e.g., is tapered) toward the pumping chamber 354 to form a lipped surface 400 of the wall 376. In the second orientation 12, the surface 374 of the retainer portion 362 abuts the lipped surface 400, thereby blocking movement of the retainer 352 in direction 62. Furthermore, the biasing member 72 imparts a force against the retainer 352 to bias the retainer 352 away from the valve 358 and discourage the retainer 352 from moving in the direction 66. This force may increase when the fluid flow impinges on valve 480 and urges valve 480 to open. Accordingly, the wall 376, the lipped surface 400, the fluid flow, and the biasing member 72 cooperatively secure the retainer 352 within the retainer recess 353. Because no additional, separate components (e.g., a cover, a fastener) dedicated to securing the retainer 352 within the retainer recess 353 are used, the retainer 352 may be considered “self-locking” that is able to be secured within the retainer 352 using existing features of the fluid end 350. This improves ease of installation of the retainer 352 within the fluid end 350.

However, to enable removal of the retainer 352 from the retainer recess 353, some movement of the retainer 352 is permitted while in the second orientation 12. By way of example, the engagement between the extension 372 and the groove 370 enables the retainer 352 to move along the direction 66 (e.g., upon application of a force that overcomes the force exerted by the biasing member 356) to remove the extension 372 from the groove 370 and to disengage the surface 374 of the retainer portion 362 from the lipped surface 400. Removing the extension 372 from the groove 370 enables rotation of the retainer portion 362 relative to the wall 376, such as toward the first orientation 11. The first orientation 11 enables the retainer 352 to be removed from the fluid end 350, such as by translating the retainer 352 along the direction 62.

Although a single groove 370 is shown in the illustrated fluid end 350, the fluid end 350 can have any suitable quantity of grooves 370 configured to receive the extension 372 of the retainer 352. By way of example, the fluid end 350 may include an additional groove 370 positioned opposite the illustrated groove 370. The additional groove 370 is configured to receive the illustrated extension 372 (e.g., the retainer 352 may be rotated to position the illustrated extension 372 in either of the illustrated groove 370 or the additional groove 370).

Similarly, although the illustrated retainer 352 includes a single extension 372, the retainer 352 can have any suitable quantity of extensions 372, such as multiple extensions 372 that may each be extended into a respective groove 370 of the fluid end 350. As an example, a single retainer portion 362 may have multiple extensions 372 (e.g., positioned adjacent to one another) and/or each retainer portion 362 may have a respective extension 372. Furthermore, in certain embodiments, the extension 372 may be separate from the retainer 352, and the extension 372 may be coupled to the retainer 352 (e.g., via a fastener) to provide the retainer 352 with the extension 372. That is, the extension 372 may not be integrally formed with the retainer 352 and, instead, is removably couplable to the retainer 352. In such embodiments, existing retainers that do not currently have extensions may be retrofitted with the extension 372 disclosed herein to realize the benefits provided by the extension 372, and a retainer 352 that has the extension 372 can be modified to remove the extension 372 (e.g., for implementation in a fluid end that does not include a groove), thereby improving flexibility of retainer implementation/installation. Further still, in some embodiments, the fluid end 350 may include an extension (e.g., similar to the extension 372), and the retainer 352 may include a groove (e.g., similar to the groove 370) configured to receive the extension of the fluid end 350 to secure the retainer 352 within the fluid end 350.

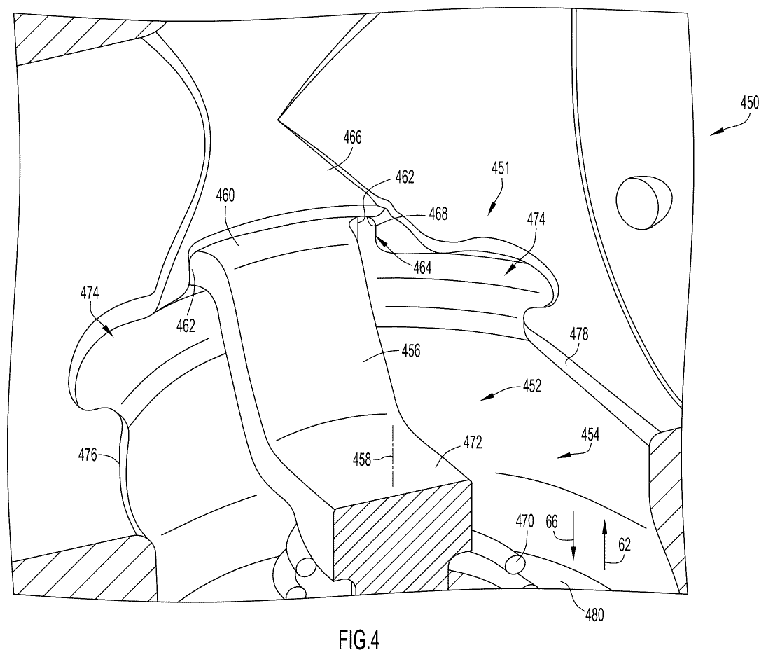

Other arrangements of grooves and extensions can be utilized to secure a retainer within a fluid end. FIG. 4 illustrates a fluid end 450 with a valve assembly 451 that includes a retainer 452 positioned in a retainer recess 454. The retainer 452 includes a retainer portion 456 (e.g., a flange) extending at least partially circumferentially about a center axis 458 extending through the retainer 452 and a valve 480 of the valve assembly 451. The retainer portion 456 includes a surface 460, as well as extensions 462 extending from the surface 460 at opposite sides of the retainer portion 456. For example, the extensions 462 may each extend circumferentially beyond the retainer portion 456.

The retainer 452 is in the second orientation 12 in the illustrated arrangement of FIG. 4. In the second orientation 12, the retainer portion 456 is configured to extend at least partially within a groove 464 formed in an inner surface of a wall 466 of the fluid end 450. Extending the retainer portion 456 within the groove 464 causes the wall 466 to capture the extensions 462, thereby blocking rotation of the retainer portion 456 relative to the wall 466. Moreover, extending the retainer portion 456 within the groove 464 causes the surface 460 to abut a lipped surface 468 formed by the wall 466 (e.g., via a biasing force exerted by a biasing member 470 coupled to a base portion 472 of the retainer 452).

To enable the retainer 452 to be positioned in the second orientation 12, cutouts 474 are formed in transition areas 476 and 478 (e.g., inwardly extending rims). At least one of the cutouts 474 is configured to receive the retainer portion 456 and the extensions 462 to enable translation of the retainer 452 in the directions 62 and 66 into and out of the retainer recess 454. For instance, to install the retainer 452 within the fluid end 450, the retainer 452 is initially moved in the direction 66 toward the valve 480 to compress the biasing member 470 until the retainer portion 456 and the extensions 462 are moved through one of the cutouts 474 such that the retainer 452 is fully positioned within the retainer recess 454 (e.g., the retainer 452 is underneath the transition areas 476 and 478). The retainer 452 is then rotated until the surface 460 of the retainer portion 456 overlaps with the groove 464, upon which the retainer 452 is released to cause the biasing member 470 to urge the surface 460 of the retainer portion 456 against the lipped surface 468 of the wall 466. Consequently, the lipped surface 468 blocks movement of the retainer 452 in the direction 62, the biasing member 470 blocks movement of the retainer 452 in the direction 66, and the wall 466 blocks rotation of the retainer 452 about the center axis 458 to cooperatively secure the retainer 452 in the retainer recess 454. Additionally, the groove 464 enables movement of the retainer 452 in the direction 66 (e.g., upon application of a force that overcomes the force exerted by the biasing member 470) to remove the retainer portion 456 from the groove 464, thereby enabling rotation of the retainer 452 relative to the wall 466. As a result, the retainer 452 may be rotated to align the retainer portion 456 and the extensions 462 with one of the cutouts 474 to enable the retainer 452 to be moved in the direction 62 through the cutouts 474.

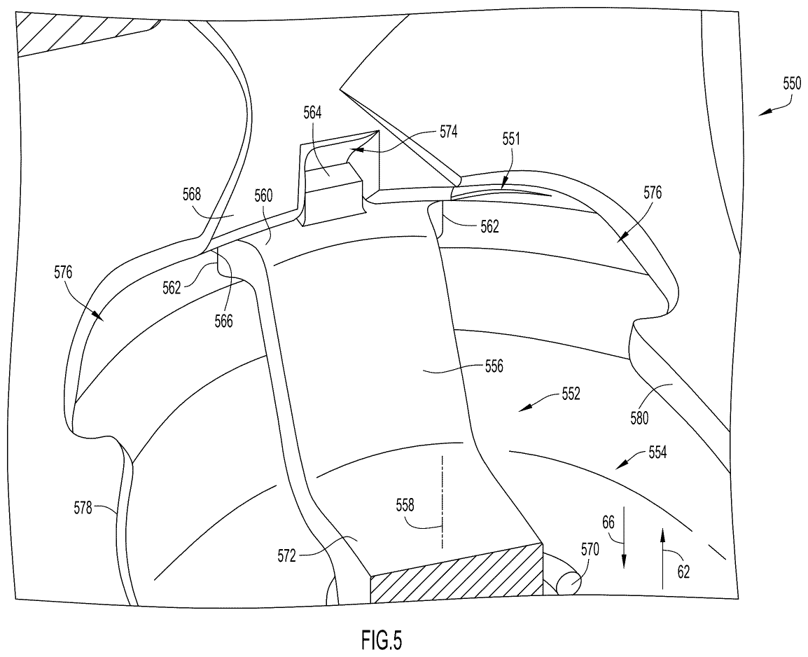

FIG. 5 illustrates a fluid end 550 with a valve assembly 551 that includes a retainer 552 positioned in a retainer recess 554. The retainer 552 includes a retainer portion 556 (e.g., a flange) extending at least partially circumferentially about a center axis 558 extending through the retainer 552 and a valve (not shown) of the valve assembly 551. The retainer portion 556 includes a surface 560, as well as first extensions 562 extending from the surface 560 at opposite sides of the retainer portion 556 and circumferentially beyond the retainer portion 556. The retainer 552 further includes a second extension 564 extending (e.g., elevationally) from the surface 560 along the center axis 558. Thus, the first extensions 562 and the second extension 564 extend from the surface 560 in transverse directions.

The retainer 552 is in the second orientation 12 in the illustrated arrangement of FIG. 5. In the second orientation 12, the surface 560 abuts a lipped surface 566 formed by a wall 568 of the fluid end 550. For instance, a biasing member 570 coupled to a base portion 572 of the retainer 552 may exert a biasing force against the retainer 552 in the direction 62 to urge the surface 560 of the retainer portion 556 against the lipped surface 566 of the wall 568. Thus, the lipped surface 566 blocks further movement of the retainer 552 in the direction 62. Moreover, a groove 574 is formed into an inner surface of the wall 568 (e.g., into the lipped surface 566), and the second extension 564 extends into the groove 574 in the second orientation 12. Consequently, the wall 568 captures the second extension 564 to block rotation of the retainer 552 about the center axis 558. However, in the second orientation 12, the first extensions 562 are positioned external to the groove 574. For instance, the first extensions 562 may abut the lipped surface 566.

Although the illustrated retainer 552 includes the first extensions 562 and the second extension 564, in alternative embodiments, the retainer 552 may include the second extension 564 and not the first extensions 562. Accordingly, the retainer 552 may be secured in the retainer recess 554 by positioning the second extension 564 within the groove 574 and abutting the surface 560 against the lipped surface 566. In further embodiments, the wall 568 includes multiple grooves to receive the first extensions 562 and the second extension 564, respectively. That is, the wall 568 includes a first groove (e.g., similar to the groove 464 of the fluid end 450) configured to receive the retainer portion 556 and the first extensions 562 and a second groove (e.g., similar to the illustrated groove 574) configured to receive the second extension 564. Positioning the first extensions 562 and the second extension 564 into the respective grooves may further increase securement of the retainer 552 within the retainer recess 554, such as by restricting rotation of the retainer 552 relative to the wall 568.

Similar to the fluid end 450, the fluid end 550 also includes cutouts 576 formed in transition areas 578 and 580 (e.g., inwardly extending rims) to enable movement of the retainer portion 556 and the first extensions 562 past the cutouts 576 for subsequent rotation to engage against the lipped surface 566. For this reason, the retainer 552 may be similarly installed into and removed from the fluid end 550 (e.g., by moving the retainer 552 in the direction 66 past the transition areas 578 and 580 and rotating to position the second extension 564 in the groove 574; by moving the retainer 552 in the direction 66 to remove the second extension 564 from the groove 574 and rotating to align the retainer portion 556 with one of the cutouts 576 to enable movement of the retainer 552 in the direction 62 past the transition areas 578, 580).

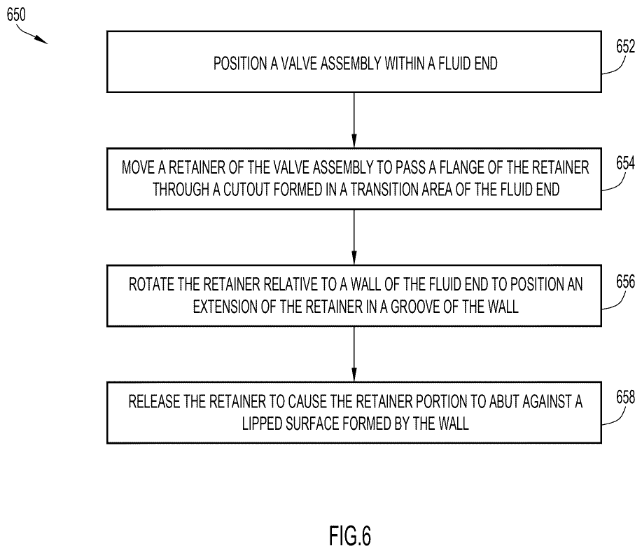

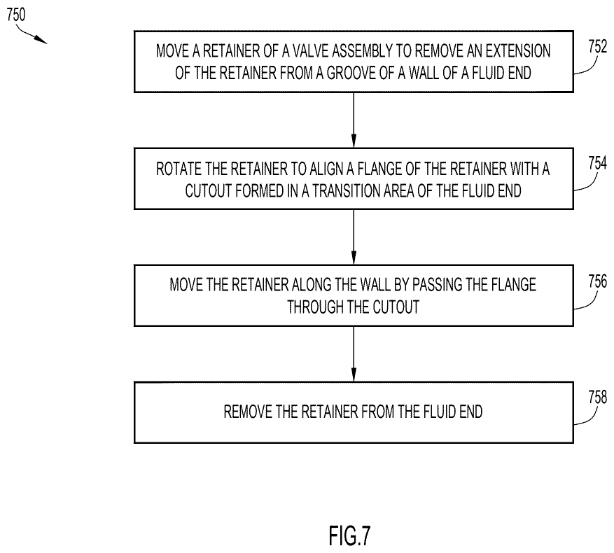

FIGS. 6 and 7 discussed below illustrate respective methods related to positioning a valve assembly (e.g., any of the valve assemblies 351, 451, 551) with respect to a fluid end (e.g., any of the fluid ends 104, 104′, 300, 350, 450, 550). It should be noted that each method may be performed differently than depicted. For example, an additional operation may be performed for either of the methods. Additionally or alternatively, any of the depicted operations may be performed differently, not performed, and/or performed in a different order. Moreover, the respective operations of the methods may be performed in any suitable manner with respect to one another, such as sequentially and/or in parallel to one another.

FIG. 6 is a flowchart of a method 650 for installing a valve assembly within a fluid end. At block 652, the valve assembly is positioned within the fluid end. As an example, a valve of the valve assembly may initially be inserted into a valve seat, which may extend adjacent to or within a bore segment of the fluid end. A biasing member is coupled to the valve assembly, and a retainer of the valve assembly is subsequently inserted into the fluid end. A base portion of the retainer is placed in engagement with the biasing member, thereby causing the biasing member to exert a force against the retainer. Such positioning of the retainer may arrange the retainer within the bore segment adjacent to or within which the valve is positioned, within a pumping chamber in which the bore segment and a transversely extending bore segment intersect, and/or within an additional bore segment extending opposite of the bore segment adjacent to or within which the valve is positioned (i.e., the pumping chamber extends between the bore segment and the additional bore segment).

The retainer includes at least one retainer portion or flange extending from the base portion (e.g., to form a U-shaped or V-shaped arrangement), as well as an extension extending from a surface of the retainer portion. Additionally, the fluid end includes a transition area (e.g., a valve cover transition area, a reciprocation bore transition area) or inwardly extending rims within the fluid end. The flange extends beyond the transition area such that movement of the retainer toward the valve abuts the flange against the transition area. However, a cutout is formed in the transition area, and the retainer may be rotated relative to the transition areas to align the retainer portion with the cutout. Subsequently, at block 654, the retainer may then be moved (e.g., translated) toward the valve (e.g., via application of a force that overcomes a force exerted by the biasing member against the retainer) to pass the retainer portion through the cutout.

After passing the retainer portion through the cutout, the retainer is able to be rotated relative to the transition areas, as shown at block 656. In particular, the retainer is rotated relative to a wall of the fluid end to position the extension in a groove formed in the wall. In some embodiments, the extension extends radially beyond the retainer portion. In additional or alternative embodiments, the extension extends circumferentially beyond the retainer. In further embodiments, the extension extends axially or elevationally beyond the retainer (e.g., along a center axis extending through the retainer and the valve). In any of these embodiments, the groove of the fluid end is configured to receive the extension such that the wall captures the extension, thereby blocking further rotation of the retainer relative to the wall.

At block 658, the retainer is released to cause the retainer portion to abut against a lipped surface formed by the wall. Specifically, the wall extends inwardly to form the lipped surface (e.g., a tapered surface), and releasing the retainer causes the biasing member to urge the retainer portion away from the valve and against the lipped surface of the wall. Accordingly, abutting the retainer portion against the lipped surface blocks further movement of the retainer away from the valve, whereas the biasing force imparted by the biasing member against the retainer blocks movement of the retainer toward the valve and the wall capturing the extension of the retainer within the groove of the fluid end blocks rotation of the retainer relative to the wall. As a result, the retainer is secured within the fluid end.

FIG. 7 is a flowchart of a method 750 for removing a retainer of a valve assembly from a fluid end, such as for a maintenance operation (e.g., inspection, replacement, repair). The retainer includes a base portion and at least one retainer portion or flange extending from the base portion. The retainer also includes an extension extending (e.g., radially, circumferentially, elevationally) from the retainer portion. The retainer is initially positioned such that the extension is positioned within a groove of a wall of the fluid end to secure the retainer within the fluid end by capturing the extension via the wall. At block 752, the retainer is moved (e.g., translated) to remove the extension from the groove. For example, a biasing member may be coupled to the retainer and to a valve of the valve assembly, and the biasing member may urge the retainer away from the biasing member to position the extension within the groove. A force may be applied to overcome the force imparted by the biasing member to move the retainer toward the valve, thereby removing the extension from the groove. As a result of removing the extension from the groove, the wall no longer captures the extension, and the retainer is therefore able to be rotated relative to the wall.

At block 754, the retainer is rotated to align the retainer portion with a cutout formed in a transition area (e.g., an inwardly extending rim) of the fluid end. For example, the retainer may be initially positioned such that the transition area extends over the retainer portion to block movement of the retainer (e.g., away from the valve). However, rotating the retainer to align the retainer portion with the cutout reduces overlap between the transition area and the retainer, and the cutout is sized to accommodate the retainer portion to enable movement of the retainer portion past the transition area.

At block 756, the retainer is moved along the wall by passing the retainer portion through the cutout. Consequently, the retainer is able to be moved without being blocked by the transition areas. At block 758, the retainer is moved further along the wall to remove the retainer from the fluid end. In certain embodiments, the valve and/or the biasing member are removed with the retainer. Indeed, an entirety of the valve assembly may be removed. Alternatively, the retainer is removed from the fluid end while the biasing member and/or the valve remain installed within the fluid end.

In each of the methods 650, 750, the retainer may be positioned with respect to the fluid end without usage of additional, dedicated components or tooling. Thus, a cost associated with installation and/or removal of the retainer with respect to the fluid end may be reduced. Additionally or alternatively, a flexibility of retainer implementation may be improved, such as to enable securement of the retainer in the fluid end (among implementation of other components in the fluid end) without having to utilize or accommodate for a particular component (e.g., a sufficiently long cover) that is able to secure certain configurations of the retainer (e.g., for a non-circular fluid end). Furthermore, installation and/or removal of the retainer with respect to the fluid end may be more readily performed by utilizing existing features already implemented in the fluid end and/or the retainer.

While the disclosure has been illustrated and described in detail and with reference to specific embodiments thereof, it is nevertheless not intended to be limited to the details shown, since it will be apparent that various modifications and structural changes may be made therein without departing from the scope of the disclosure and within the scope and range of equivalents of the claims. In addition, various features from one of the embodiments may be incorporated into another of the embodiments. Indeed, the techniques described herein can apply to any fluid end. Accordingly, it is appropriate that the appended claims be construed broadly and in a manner consistent with the scope of the disclosure as set forth in the following claims.

Similarly, it is intended that the present disclosure cover the modifications and variations of this disclosure that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.”

What is claimed is:

1. A valve assembly for a fluid end, the valve assembly comprising:
a valve configured to seal a bore segment of the fluid end; and
a retainer configured to secure the valve within the fluid end, wherein the retainer comprises:
a flange having a surface configured to engage a wall of the fluid end; and
an extension extending from the surface and configured to extend into a groove formed in the fluid end to block rotation of the retainer within the fluid end.

2. The valve assembly of claim 1, comprising a biasing member coupling the valve and the retainer to one another, wherein the biasing member is configured to urge the retainer away from the valve to secure the retainer within the groove of the fluid end.

3. The valve assembly of claim 1, wherein the flange extends at least partially circumferentially about a center axis extending through the valve and the retainer.

4. The valve assembly of claim 3, wherein the extension extends radially beyond the flange.

5. The valve assembly of claim 3, wherein the extension extends circumferentially beyond the flange.

6. The valve assembly of claim 3, wherein the extension extends along the center axis beyond the flange.

7. The valve assembly of claim 6, comprising an additional extension extending circumferentially beyond the flange.

8. The valve assembly of claim 7, wherein the additional extension is configured to engage a lipped surface formed by the wall of the fluid end external to the groove.

9. The valve assembly of claim 1, wherein the extension allows axial movement of the retainer relative to the wall while positioned in the groove of the fluid end.

10. A fluid end, comprising:
an inner surface comprising a groove; and
a valve assembly comprising a retainer configured to secure the valve assembly within the fluid end, wherein the retainer comprises a flange configured to engage the inner surface of the fluid end, and the retainer comprises an extension extending from the flange and configured to extend into the groove of the inner surface of the fluid end to block rotation of the retainer relative to a wall of the fluid end.

11. The fluid end of claim 10, comprising an inwardly extending rim and a cutout formed in the inwardly extending rim, wherein the cutout is configured to receive the flange to enable movement of the flange past the inwardly extending rim for engaging the flange with the inner surface.

12. The fluid end of claim 10, wherein the inner surface is defined by the wall of the fluid end.

13. The fluid end of claim 10, comprising a bore segment, wherein the valve assembly comprises a valve configured to selectively seal the bore segment, and the retainer is configured to secure the valve in the fluid end.

14. The fluid end of claim 13, wherein the bore segment comprises an intake bore segment configured to receive fluid.

15. The fluid end of claim 13, comprising an additional bore segment intersecting the bore segment at a pumping chamber of the fluid end, wherein the groove is formed in the inner surface within the pumping chamber.

16. A retainer of a valve assembly for a fluid end, the retainer comprising:
a base portion configured to couple to a biasing member to urge a valve of the valve assembly away from the retainer;
a retainer portion extending from the base portion, wherein the retainer portion extends at least partially circumferentially about a center axis extending through the retainer; and
an extension extending from a surface of the retainer portion, wherein the extension is configured to extend into a groove formed in the fluid end to block rotation of the retainer within the fluid end.

17. The retainer of claim 16, wherein the extension extends radially beyond the retainer portion.

18. The retainer of claim 16, wherein the extension extends circumferentially beyond the retainer portion.

19. The retainer of claim 18, comprising an additional extension extending from the surface of the retainer portion, wherein the additional extension and the extension extend from opposite sides of the retainer portion, and the additional extension extends circumferentially beyond the retainer portion.

20. The retainer of claim 16, wherein the extension extends along the center axis, and the retainer comprises an additional extension that extends from the surface of the retainer, the additional extension extending circumferentially beyond the retainer portion.
